(19) United States
(12) Patent Application Publication
(10) Pub. No.: US 2016/0101758 A1
(43) Pub. Date: Apr. 14, 2016

(54) VEHICLE SIDE AIRBAG DEVICE

(71) Applicant: TOYOTA JIDOSHA KABUSHIKI KAISHA, Toyota-shi (JP)

(72) Inventor: Yusuke FUJIWARA, Toyota-shi (JP)

(21) Appl. No.: 14/876,267

(22) Filed: Oct. 6, 2015

(30) Foreign Application Priority Data
Oct. 10, 2014 (JP) 2014-209128

(51) Int. Cl. B60R 21/231; B60R 21/2334; B60R 21/233; B60R 21/207

(52) U.S. Cl. CPC B60R 21/23138; B60R 21/207; B60R 21/2334; B60R 21/233; B60R 2021/23146; B60R 2021/23324

(57) ABSTRACT

A vehicle side airbag device including: an inflator disposed at a side section of a seatback of a vehicle seat; a rear bag section that inflates and deploys using gas from the inflator housed therein; a front bag section into which gas is supplied through communication openings formed at a partitioning section between the front and rear bag sections, that inflates and deploys toward a vehicle front and upper side of the rear bag section, and that protects a head of an occupant at a vehicle upper side than the rear bag section; and a diffuser that is disposed inside the rear bag section, that houses the inflator and inflates using gas therefrom, wherein an upper end portion of the diffuser, where inflates, pierces through an upper communication opening that is one of the communication openings formed at an upper end portion of the partitioning section.

### CROSS-REFERENCE TO RELATED APPLICATION

This application is based on and claims priority under 35 USC 119 from Japanese Patent Application No. 2014-209128 filed on Oct. 10, 2014, the disclosure of which is incorporated by reference herein.

### BACKGROUND

1. Technical Field

The present disclosure relates to a vehicle side airbag device.

2. Related Art

In an airbag device (side airbag device) described in Japanese Patent Application Laid-Open (JP-A) No. 2012-051557, an airbag bag body includes an inflation location that inflates on receipt of gas supplied from an inflator, and a non-inflation location. An opening is formed at the non-inflation location, and a tether inserted through the opening connects a rear end portion and a front end portion of the airbag bag body. A deployment trajectory of the airbag bag body is controlled by the tether.

However, the structure of the side airbag device described above is such that the airbag bag body is set with a large vehicle up-down direction dimension, and an upper portion of the airbag bag body that protects the head of an occupant is not directly fixed to a seatback. Therefore, in cases in which a flow of gas ejected into the airbag bag body from the inflator is not well controlled, there is a possibility of the upper portion of the airbag bag body swaying greatly during inflation and deployment. There is accordingly room for improvement from the perspective of improving head protection performance.

### SUMMARY

In consideration of the above circumstances, the present disclosure provides a vehicle side airbag device that contributes to improving head protection portion.

An aspect of the present invention is a vehicle side airbag device including: an inflator that is disposed at a side section of a seatback of a vehicle seat; a rear bag section that inflates and deploys using gas from the inflator housed inside the rear bag section; a front bag section into which gas is supplied through plural communication openings formed at a partitioning section between the front bag section and the rear bag section, that inflates and deploys toward a vehicle front side and a vehicle upper side of the rear bag section, and that protects a head of an occupant at a location at a vehicle upper side than the rear bag section; and a diffuser that is disposed inside the rear bag section, that houses the inflator and inflates using gas from the inflator, wherein an upper end portion of the diffuser, which is a portion at a location that inflates, pierces through an upper communication opening that is one of the plural communication openings formed at an upper end portion of the partitioning section.

In the present aspect, the inflator is operated, for example, in the event of a side collision of the vehicle. The rear bag section housed inside the inflator inflates and deploys using gas from the inflator. Gas is supplied into the front bag section through the plural communication holes formed at the partitioning section between the rear bag section and the front bag section, and the front bag section inflates and deploys toward the vehicle front side and the vehicle upper side of the rear bag section. The front bag section protects the head of the occupant at a location (hereafter referred to as a “head protection portion”) that is vehicle upper side than the rear bag section.

When the inflator has operated as described above, the rear bag section with the inflator housed inside can be inflated and deployed at an earlier stage and at a higher pressure than the front bag section, thereby enabling the lower pressure front bag section that inflates and deploys with a delay to be supported by the higher pressure rear bag section. Moreover, the inflator is housed inside the diffuser provided inside the rear bag section, and the diffuser inflates at an earlier stage and at a higher pressure than the rear bag section. The upper end portion of the diffuser pierces through the upper communication opening formed at the upper end portion of the partitioning section, thereby enabling unintentional folding of the airbag originating at the upper communication opening to be prevented or suppressed by the inflated diffuser. This enables deployment behavior of the head protection portion of the front bag section to be stabilized, thereby contributing to improving head protection performance.

The present aspect may be configured such that a gas flow-path region, for supplying a portion of gas supplied into the rear bag section from the diffuser to an upper portion inside the front bag section, is formed at the upper communication opening.

In the above configuration, a portion of the gas generated by the inflator and supplied into the rear bag section from the diffuser is supplied to the upper portion inside the front bag section through the gas flow-path region of the upper communication opening set at the upper end portion of the partitioning section. Since the upper end portion of the diffuser pierces through the upper communication opening, a flow rate of gas supplied to the upper portion inside the front bag section through the gas flow-path region can be adjusted by adjusting the outer profile of the upper end portion of the diffuser during inflation. Moreover, in order to reduce the flow rate of gas passing through the gas flow-path region, it is sufficient to increase the outer profile of the upper end portion of the diffuser, without having to reduce the opening area of the upper communication opening, thereby enabling configuration such that inflation thickness of the airbag in the vicinity of the upper communication opening does not become excessively thin. This contributes to preventing or suppressing the airbag from folding originating at the upper communication opening.

The present aspect may be configured such that the plural communication openings include a lower communication opening formed at a lower end portion of the partitioning section; and a cross-section area of the gas flow-path region, when the rear bag section and the front bag section is inflated and deployed, is set smaller than an opening area of the lower communication opening.

The present aspect may be configured such that the plural communication openings include a lower communication opening formed at a lower end portion of the partitioning section; and the diffuser increases in diameter from an upper end toward a lower end thereof, and a lower end opening is formed at the lower end.

In the above configurations, gas generated by the inflator is supplied into the rear bag section from the lower end opening of the diffuser, and also supplied to the lower portion inside the front bag section through the lower communication opening formed at the lower end portion of the partitioning section. A portion of the gas supplied into the rear bag section is supplied to the upper portion inside the front bag section through the gas flow-path region of the upper communication opening set at the upper end portion of the partitioning section.

In the present aspect, as previously described, the cross-section area of the gas flow-path region of the upper communication opening can be adjusted by adjusting the outer profile of the upper end portion of the diffuser during inflation. This enables, for example, the flow rate of gas supplied to the upper portion inside the front bag section through the gas flow-path region of the upper communication opening to be reduced, while increasing a flow rate of gas supplied to the lower portion inside the front bag section through the lower communication opening. Since a portion of the gas that is supplied to the lower portion inside the front bag section at a greater flow rate flows toward the upper portion inside the front bag section, the upper portion inside the front bag section, namely, the head protection portion, is supplied with gas along two paths, these being the path from the gas flow-path region, and the path from the lower portion inside the front bag section. The head protection portion can be stably inflated and deployed from bottom to top by a favorable balance of the flow rates of the gas supplied along these two paths.

The present aspect may be configured such that, during operation of the inflator, an internal pressure of the diffuser is higher than an internal pressure of the rear bag section, and the internal pressure of the rear bag section is higher than an internal pressure of the front bag section.

The rear bag section with the diffuser and the inflator provided inside can be inflated and deployed at an earlier stage and at a higher pressure than the front bag section, thereby enabling the lower pressure front bag section that inflates and deploys with a delay to be supported by the higher pressure rear bag section. Moreover the upper end portion of the diffuser that inflates at an earlier stage and at a higher pressure than the rear bag section pierces through the upper communication opening set at the upper end portion of the partitioning section. This enables unintentional folding of the airbag originating at the upper communication opening to be prevented or suppressed by the rigidity of the inflated diffuser. This enables deployment behavior of the head protection portion provided at the upper portion of the front bag section to be stabilized, thereby enabling the head to be stably protected by the head protection portion, and contributing to improving head protection performance.

The present aspect may be configured such that the diffuser includes an opening that is formed at the upper end side than the lower end thereof.

In the above configuration, gas generated by the inflator is emitted to the outside of the diffuser from the lower end opening of the diffuser, and emitted to the outside of the diffuser from the opening formed at the upper end side than the lower end of the diffuser. Adding the opening to the diffuser in this manner contributes to preventing an excessive rise in the internal pressure of the diffuser.

The present aspect may be configured such that the plural communication openings include a lower communication opening formed at a lower end portion of the partitioning section; and the diffuser includes: an upper side opening that is formed at an upper end portion thereof, and that places an interior of the diffuser and an interior of the front bag section in communication with each other; an intermediate opening that is formed at an up-down direction intermediate portion thereof, and that places the interior of the diffuser and an interior of the rear bag section in communication with each other; a lower end portion that pierces through the lower communication opening; and a lower side opening that is formed at the lower end portion, and that places the interior of the diffuser and the interior of the front bag section in communication with each other.

In the above configuration, gas generated by the inflator is supplied to the upper portion inside the front bag section from the upper side opening formed at the upper end portion of the diffuser, supplied into the rear bag section from the intermediate opening formed at the up-down direction intermediate portion of the diffuser, and supplied to the lower portion inside the front bag section from the lower side opening formed at the lower end portion of the diffuser.

In the above configuration, adjusting the respective opening areas of the lower side opening and the upper side opening enables the flow rate of gas supplied to the upper portion inside the front bag section from the upper side opening to be reduced, while increasing the flow rate of gas supplied to the lower portion inside the front bag section from the lower side opening. Since a portion of the gas that is supplied to the lower portion inside the front bag section at a greater flow rate flows toward the upper portion inside the front bag section, the upper portion inside the front bag section, namely, the head protection portion, is supplied with gas along two paths, these being the path from the upper side opening, and the path from the lower portion inside the front bag section. The head protection portion can be stably inflated and deployed from bottom to top by a favorable balance of the flow rates of the gas supplied along these two paths. Forming the upper side opening, the intermediate opening, and the lower side opening to the diffuser also contributes to preventing or suppressing an excessive rise in the internal pressure of the diffuser.

The present aspect may be configured such that the plural communication openings include an intermediate communication opening formed at an up-down direction intermediate portion of the partitioning section.

In the above configuration, a portion of the gas supplied into the rear bag section is supplied into the front bag section through the upper communication opening, the intermediate communication opening, and the lower communication opening of the partitioning section. Adding the intermediate communication opening to the partitioning section in this manner contributes to preventing an excessive rise in the internal pressure of the rear bag section. Note that in this configuration, the flow rate of gas supplied to the lower portion inside the front bag section is adjusted by adjusting the opening area of the intermediate communication opening and the lower communication opening.

As explained above, a vehicle side airbag device according to the present aspect contributes to improving head protection performance.

### BRIEF DESCRIPTION OF THE DRAWINGS

Exemplary embodiments will be described in detail based on the following figures, wherein:

FIG. 1 is a side view of a vehicle seat installed with a vehicle side airbag device according to a first exemplary embodiment, illustrating an inflated and deployed state of an airbag;

FIG. 2 is an enlarged cross-section illustrating an enlarged cross-section taken along line F2-F2 in FIG. 1;

FIG. 3 is an enlarged cross-section illustrating an enlarged cross-section taken along line F3-F3 in FIG. 1;

FIG. 4 is a side view of a vehicle side airbag device according to a second exemplary embodiment, illustrating an inflated and deployed state of an airbag;

FIG. 5 is a side view of a vehicle side airbag device according to a third exemplary embodiment, illustrating an inflated and deployed state of an airbag; and

FIG. 6 is an opened-out plan view of the airbag illustrated in FIG. 5.

### DETAILED DESCRIPTION

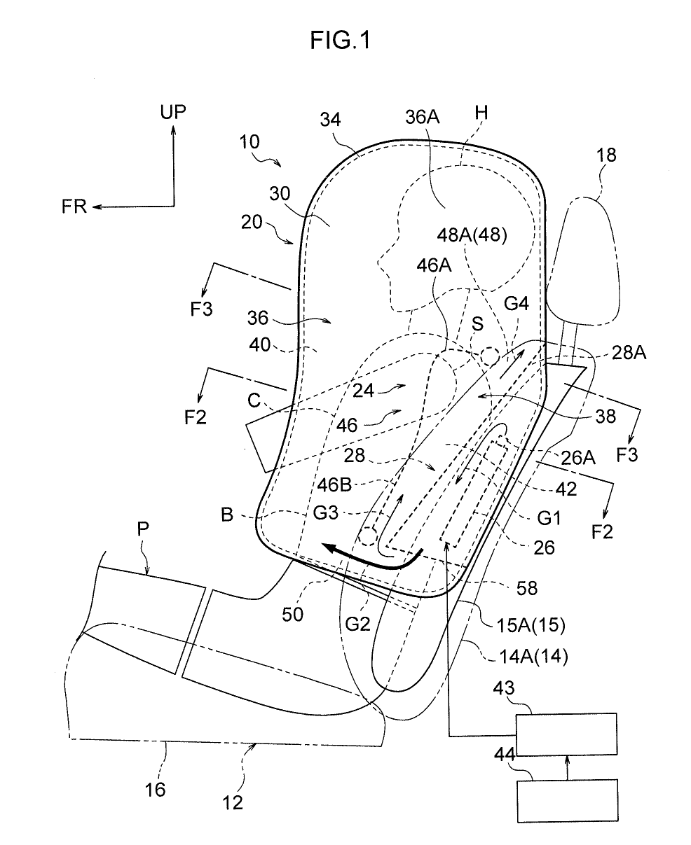

Explanation follows regarding a vehicle side airbag device 10 according to a first exemplary embodiment, with reference to FIG. 1 to FIG. 3. Note that in each of the drawings, the arrow FR, the arrow UP, and the arrow OUT indicate the front direction (direction of travel), the upper direction, and the outside in the width direction of the vehicle, respectively. Unless specifically stated otherwise, reference simply to the front-rear, left-right, and up-down directions in the below explanation refers to the vehicle front-rear direction, the vehicle left-right direction (vehicle width direction), and the vehicle up-down direction.

### Configuration

The vehicle side airbag device 10 illustrated in FIG. 1 is a far side airbag device, and is installed to a side support section 14A at a vehicle center side (a side section at a vehicle width direction center side, hereafter simply referred to as “center-side side section 14A”) of a seatback 14 of a vehicle seat 12. The vehicle seat 12 is, for example, a driving seat in a right-hand drive vehicle. The seatback 14 of the vehicle seat 12 is reclinably coupled to a rear end section of a seat cushion 16, and an upper end section of the seatback 14 is coupled to a headrest 18.

Note that in the present exemplary embodiment, the front-rear direction, left-right direction (width direction), and up-down direction of the vehicle seat 12 are aligned with the front-rear direction, left-right direction, and up-down direction of the vehicle. In FIG. 1, a crash test dummy P is illustrated seated in the vehicle seat 12 instead of an actual occupant. The dummy P is, for example, a World Side Impact Dummy (World SID) of an American 50^{th} percentile adult male (AM50). The dummy P is seated in a standard seated posture specified in collision testing methods. A front-rear position of the seat cushion 16 with respect to the vehicle, and a slope position (slope angle) of the seatback 14 with respect to the seat cushion 16, are adjusted to reference set positions corresponding to the seated posture. In order to facilitate understanding of the explanation, the dummy P is hereafter referred to as “occupant p”.

The vehicle side airbag device 10 is a device mainly for protecting an occupant at the opposite side to a collision side in the event of a side collision of the vehicle, and includes an airbag 20 (far side airbag, bag body) installed at the center-side side section 14A. The airbag 20 is partitioned into a front bag section 36 and a rear bag section 38 by a partitioning section 24, and an inflator 26 and a diffuser 28 are installed inside the rear bag section 38.

The airbag 20 configures a module together with the inflator 26 and the diffuser 28, and is normally housed in a folded state inside the center-side side section 14A. The airbag 20 inflates and deploys toward the vehicle width direction center side of the occupant P (the front side of the center-side side section 14A) due to pressure from gas generated by the inflator 26 (the state illustrated in FIG. 1). A seatback pad and a seat cover (neither of which are illustrated in the drawings) installed to the center-side side section 14A are configured so as to rupture under inflation pressure of the airbag 20 during inflation and deployment. Note that in the explanation below, unless specifically stated otherwise, front-rear and up-down directions of the airbag 20 refer to directions of the airbag 20 in the inflated and deployed state, and are substantially aligned with the front-rear and up-down directions of the seatback 14.

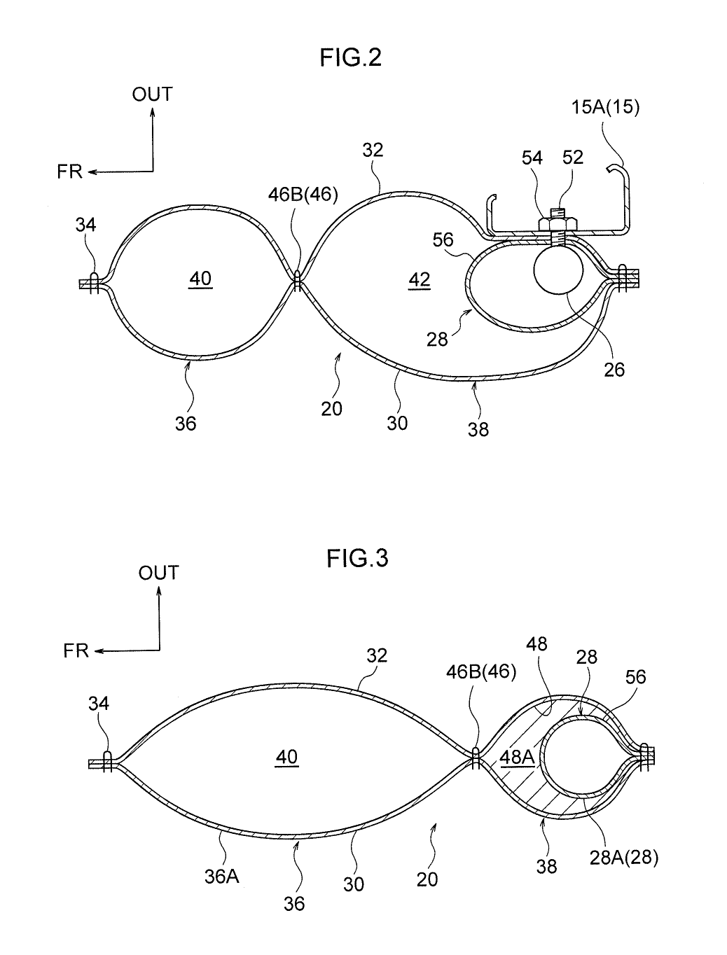

The airbag 20 is formed in an elongated bag shape by superimposing two base cloths 30, 32 (see FIG. 2 and FIG. 3), formed by cutting out a cloth material made of nylon thread or polyester thread, for example, and stitching together outer peripheral edge portions at an outer peripheral stitch section 34. When viewed from the side face (the vehicle width direction center side in this example) in the inflated and deployed state illustrated in FIG. 1, the airbag 20 is formed in an elongated, substantially rectangular shape along the vehicle up-down direction, capable of protecting (restraining) the occupant P from the head H as far as the abdominal region B. Note that FIG. 1 illustrates a state directly before the airbag 20 restrains the occupant P from the head H as far as the abdominal region B (a non-restraining inflated and deployed state, hereafter simply referred to as “inflated and deployed state”).

The airbag 20 is partitioned by the above-mentioned partitioning section 24 into the front bag section 36 for protecting (restraining) the occupant P at front portions of the chest C and abdominal region B, and at the head H, and the rear bag section 38 for protecting (restraining) the occupant P at rear portions of the chest C and abdominal region B, and at the shoulder region S. A front chamber 40 is configured inside the front bag section 36, and a rear chamber 42 is configured inside the rear bag section 38.

The partitioning section 24 is configured by a stitched section (seam) 46 at which the base cloths 30, 32 are stitched together, and an upper communication opening 48 and a lower communication opening 50 that are inner vent holes. In the inflated and deployed state of the airbag 20, the stitched section 46 includes a crosswise extension portion 46A, extending from an up-down direction intermediate portion in the vicinity of a rear end portion of the airbag 20 toward the front side of the seatback 14, to reach the vicinity of a front-rear direction center portion of the airbag 20. An upright extension portion 46B extends from a front end portion of the crosswise extension portion 46A toward a lower end side of the airbag 20.

The stitched section 46 is partially omitted between a rear end of the crosswise extension portion 46A and a rear end of the airbag 20. The upper communication opening 48 is formed at the location where the stitched section 46 is partially omitted (an unstitched portion). Similarly, the stitched section 46 is partially omitted between a lower end of the upright extension portion 46B and the lower end of the airbag 20. The lower communication opening 50 is formed at the location where the stitched section 46 is partially omitted (an unstitched portion). Note that the ends at the rear end of the crosswise extension portion 46A and the lower end of the upright extension portion 46B are each treated by stitching in a circular shape.

The upper communication opening 48 is set at an upper end portion of the partitioning section 24, and places an upper portion inside the front bag section 36 and an upper end portion inside the rear bag section 38 in communication with each other along the up-down direction of the airbag 20 at an up-down direction intermediate portion of the rear end portion of the airbag 20. The lower communication opening 50 is set at a lower end portion of the partitioning section 24, and places a lower end portion inside the front bag section 36 and a lower end portion inside the rear bag section 38 in communication with each other along the front-rear direction of the airbag 20 at a front-rear direction intermediate portion of the lower end portion of the airbag 20.

In the inflated and deployed state of the airbag 20 with the above configuration, the upright extension portion 46B of the partitioning section 24 faces front-rear direction intermediate portions of the chest C and the abdominal region B of the occupant P from the vehicle width direction inside. In this state, the rear bag section 38 faces the rear portions of the chest C and abdominal region B, and the shoulder region S of the occupant P from the vehicle width direction center side, and the front bag section 36 faces the front portions of the chest C and abdominal region B, and the head H of the occupant P from the vehicle width direction center side. The front bag section 36 protects the head H of the occupant P using a head protection portion 36A, this being a location at the vehicle upper side than the partitioning section 24 and the rear bag section 38.

As illustrated in FIG. 1 and FIG. 2, the inflator 26 is a cylinder type gas generator, and is formed in a cylindrical shape. The inflator 26 is housed at a rear end side inside the rear bag section 38 oriented with its axial line direction along the up-down direction of the seatback 14. A pair of upper and lower stud bolts 52 (see FIG. 2) project out from outer peripheral portions of the inflator 26 toward the vehicle width direction outside. The stud bolts 52 pierce through the base cloth of the air bag 20 and a side frame 15A of a seatback frame 15, and nuts 54 are screwed onto leading end sides of the stud bolts 52. The inflator 26 is thereby fastened and fixed to the seatback frame 15 together with the airbag 20.

As illustrated in FIG. 1, the inflator 26 is electrically connected to an ECU 43 (controller) installed to the vehicle. A side collision sensor 44 that detects a side collision of the vehicle is electrically connected to the ECU 43. The ECU 43 and the side collision sensor 44 are components of the vehicle side airbag device 10.

The ECU 43 is configured to operate (actuate) the inflator 26 when (the inevitability of) a side collision of the vehicle has been detected based on a signal from the side collision sensor 44. Specifically, since the vehicle side airbag device 10 according to the present exemplary embodiment is installed to the vehicle seat 12 that is the driving seat in a right-hand drive vehicle, the inflator 26 is actuated when the ECU 43 detects that another vehicle has collided with a side section (left side section) at a front passenger seat side of the vehicle. Note that, in cases in which a pre-crash sensor that predicts (forecasts) a side collision is electrically connected to the ECU 43, the inflator 26 may be configured to be actuated when the ECU 43 has predicted a side collision based on a signal from the pre-crash sensor.

The diffuser 28 is a member that is also referred to as a loop diffuser, an inner tube, or a flow-regulating cloth, and is configured by a base cloth 56, formed by cutting a cloth material, similar to the base cloths 30, 32 of the airbag 20, into a substantially triangular shape. The base cloth 56 is folded in two, and edge portions at the opposite side to the fold line where the base cloth 56 is folded in two are stitched to a rear end edge portion of the airbag 20 at the outer peripheral stitch section 34. The diffuser 28 is formed in the shape of a substantially trumpet shaped bag open toward the lower end side of the airbag 20, with an outer profile in a substantially circular conical shape increasing in diameter from an upper end toward a lower end thereof.

A lower end opening 58 is formed at a lower end of the diffuser 28, and the interior of the diffuser 28 and the interior of the rear bag section 38 are placed in communication with each other through the lower end opening 58. The lower end opening 58 is open toward the lower side of the airbag 20, and is set so as to face the above-mentioned lower communication opening 50 along the vehicle front-rear direction in the inflated and deployed state of the airbag 20 illustrated in FIG. 1.

An upper end portion 28A of the diffuser 28 pierces through the above-mentioned upper communication opening 48, extends toward the upper side of the airbag 20, and projects into the head protection portion 36A. Namely, the upper end portion 28A of the diffuser 28 overlaps with the upper communication opening 48 in the up-down direction (height direction) of the airbag 20, and straddles between inside the rear bag section 38 and inside the head protection portion 36A. The upper end of the diffuser 28 is disposed at the upper side of the airbag 20 than a location at which an opening area of the upper communication opening 48 is at a minimum. The upper end portion of the diffuser 28 is closed off in the present exemplary embodiment.

The upper end portion 28A of the diffuser 28 is positioned at the rear end side of the airbag 20 than the rear end of the crosswise extension portion 46A of the partitioning section 24. As illustrated in FIG. 3, a gas flow-path region 48A for supplying gas from inside the rear bag section 38 to inside the front bag section 36 is set at the upper communication opening 48 that is piercing through the upper end portion 28A of the diffuser 28. The gas flow-path region 48A is a gap formed between edge portions of the upper communication opening 48 and the upper end portion 28A of the diffuser 28. Note that in FIG. 3, the gas flow-path region 48A is illustrated by hatching in order to make the gas flow-path region 48A more visible.

The above-mentioned inflator 26 is housed inside the diffuser 28. As illustrated in FIG. 2, the upper and lower stud bolts 52 of the inflator 26 pierce through the base cloth 56 of the diffuser 28, and a portion of the base cloth 56 and a portion of the base cloth 32 of the airbag 20 are clamped between the side frame 15A and the inflator 26. The diffuser 28 is thereby fixed to the side frame 15A through the inflator 26.

On actuation of the inflator 26, gas is ejected in radiating directions into the diffuser 28 from a gas ejection portion 26A provided at one of either an upper end portion or a lower end portion of the inflator 26 (the upper end portion in this example), and the diffuser 28 inflates due to the pressure of the gas. As illustrated by the arrow G1 in FIG. 1, gas ejected into the diffuser 28 is directed toward the lower end side of the diffuser 28, and is supplied (ejected) into the rear bag section 38 from the lower end opening 58. The rear bag section 38 accordingly starts to inflate and deploy prior to the front bag section 36.

As illustrated by the arrow G2 in FIG. 1, a portion of the gas ejected from the lower end opening 58 passes through the lower communication opening 50 of the partitioning section 24 and is supplied (ejected) into the lower end portion inside the front bag section 36. As illustrated by the arrow G3 in FIG. 1, a portion of the gas ejected into the rear bag section 38 from the lower end opening 58 rises inside the rear bag section 38, passes through the upper communication opening 48 of the partitioning section 24, and is supplied (ejected) into the head protection portion 36A, this being the upper portion inside the front bag section 36 (see the arrow G4 in FIG. 1). The front bag section 36 accordingly starts to inflate and deploy with a delay to the rear bag section 38.

As described above, the upper end portion 28A of the diffuser 28 pierces through the upper communication opening 48 of the partitioning section 24. The upper end portion 28A inflates as illustrated in FIG. 3, such that a cross-section area of the gas flow-path region 48A of the upper communication opening 48 becomes narrower. The cross-section area of the gas flow-path region 48A that has narrowed in this manner is set so as to become smaller than an opening area of the lower communication opening 50. Configuration is thereby such that a flow rate of gas G2 (lower path gas) that passes through the lower communication opening 50 and is supplied to the lower end portion inside the front bag section 36 is greater than a flow rate of gas G4 (upper path gas) that passes through the gas flow-path region 48A and is supplied to the upper portion inside the front bag section 36.

In the present exemplary embodiment, configuration is such that, during operation of the inflator 26, an internal pressure P1 of the diffuser 28 with the inflator 26 housed inside becomes higher than an internal pressure P2 of the rear bag section 38, and the internal pressure P2 of the rear bag section 38 with the inflator 26 and the diffuser 28 provided inside becomes higher than an internal pressure P3 of the front bag section 36.

### Operation and Advantageous Effects

Next, explanation follows regarding operation and effects of the first exemplary embodiment.

In the vehicle side airbag device 10 with the above configuration, when the ECU 43 detects a side collision based on a signal from the side collision sensor 44, the inflator 26 is actuated by the ECU 43, and gas is ejected into the diffuser 28 from the gas ejection portion 26A of the inflator 26. The diffuser 28 thereby inflates, while ejecting gas into the rear bag section 38 from the lower end opening 58. A portion of the gas ejected into the rear bag section 38 passes through the upper communication opening 48 and the lower communication opening 50, and is supplied into the front bag section 36. The airbag 20 thereby inflates and deploys.

When this occurs, the rear bag section 38 with the diffuser 28 and the inflator 26 provided inside can be inflated and deployed at an earlier stage and at a higher pressure than the front bag section 36, thereby enabling the lower pressure front bag section 36 that inflates and deploys with a delay to be supported by the higher pressure rear bag section 38. Moreover, by housing the inflator 26 inside, the upper end portion 28A of the diffuser 28 that inflates at an earlier stage and at a higher pressure than the rear bag section 38 pierces through the upper communication opening 48 set at the upper end portion of the partitioning section 24. This enables unintentional folding of the airbag 20 originating at the upper communication opening 48 to be prevented or suppressed by the rigidity of the inflated diffuser 28. This enables deployment behavior of the head protection portion 36A provided at the upper portion of the front bag section 36 to be stabilized, thereby enabling the head H to be stably protected by the head protection portion 36A, and contributing to improving head protection performance.

In the present exemplary embodiment, configuration is such that the flow rate of the gas G2 that passes through the lower communication opening 50 and is supplied to the lower end portion inside the front bag section 36 is greater than the flow rate of the gas G4 that passes through the gas flow-path region 48A of the upper communication opening 48 and is supplied to the upper portion inside the front bag section 36. Since a portion of the gas G2, which is mainly supplied to the lower end portion inside the front bag section 36, flows toward the upper portion inside the front bag section 36, the upper portion inside the front bag section 36, namely, the head protection portion 36A, is supplied with gas along two paths, these being the path from the gas flow-path region 48A, and the path from the lower end portion inside the front bag section 36. The head protection portion 36A can be stably inflated and deployed from bottom to top by a favorable balance of the flow rates of the gas supplied along these two paths.

In the present exemplary embodiment, the upper end portion 28A of the diffuser 28 pierces through the upper communication opening 48, thereby enabling the cross-section area of the gas flow-path region 48A to be adjusted by adjusting the outer profile of the upper end portion 28A of the diffuser 28 during inflation. Namely, there is no need to reduce the opening area of the upper communication opening 48 in order to reduce the flow rate of gas that passes through the gas flow-path region 48A and is supplied to the upper portion inside the front bag section 36, thereby enabling configuration such that the inflation thickness of the airbag in the vicinity of the upper communication opening 48 does not become excessively thin. This enables the shape rigidity of the airbag 20 in the vicinity of the upper communication opening 48 to be secured, thereby contributing to preventing or suppressing the airbag 20 from folding originating at the upper communication opening 48. Thus, the present exemplary embodiment enables both the flow rate of gas passing through the upper communication opening 48 to be adjusted, and the shape rigidity of the airbag 20 to be secured.

In the present exemplary embodiment, the flow of gas from the higher pressure rear bag section 38 to the lower pressure front bag section 36 can be regulated by the upper communication opening 48 and the lower communication opening 50 provided at the partitioning section 24. This further contributes to the effect of stabilizing the deployment behavior of the head protection portion 36A of the front bag section 36.

In the present exemplary embodiment, the upper communication opening 48 of the partitioning section 24 places the upper end portion inside the rear bag section 38 and the upper portion inside the front bag section 36 in communication with each other along the up-down direction of the airbag 20, and the lower communication opening 50 places the lower end portion inside the rear bag section 38 and the lower end portion inside the front bag section 36 in communication with each other along the front-rear direction of the airbag 20. Configuration can accordingly be made such that the lower path gas G2 that passes through the lower communication opening 50 and is supplied to the lower end portion inside the front bag section 36 does not unintentionally impede on the upper path gas G1 that passes through the upper communication opening 48 and is supplied to the upper portion inside the front bag section 36. This accordingly also contributes to the effect of stabilizing deployment behavior of the front bag section 36.

In the present exemplary embodiment, the rear bag section 38 inflates and deploys at an earlier stage and at a higher pressure than the front bag section 36. In the body of the occupant P, the front portions of the chest C and abdominal region B, with a relatively low load resistance, can be gently restrained by the front bag section 36, while the rear portions of the chest C and abdominal region B, and the shoulder region S, with a relatively high load resistance, are effectively restrained by the rear bag section 38. This enables the occupant P to be restrained (protected) according to the load resistance of each body portion of the occupant P, thereby contributing to improving occupant protection performance.

Next, explanation follows regarding other exemplary embodiments. Note that configuration and operation that are basically the same as the above exemplary embodiment are applied with the same reference numerals as the above exemplary embodiment, and explanation thereof is omitted.

### Second Exemplary Embodiment

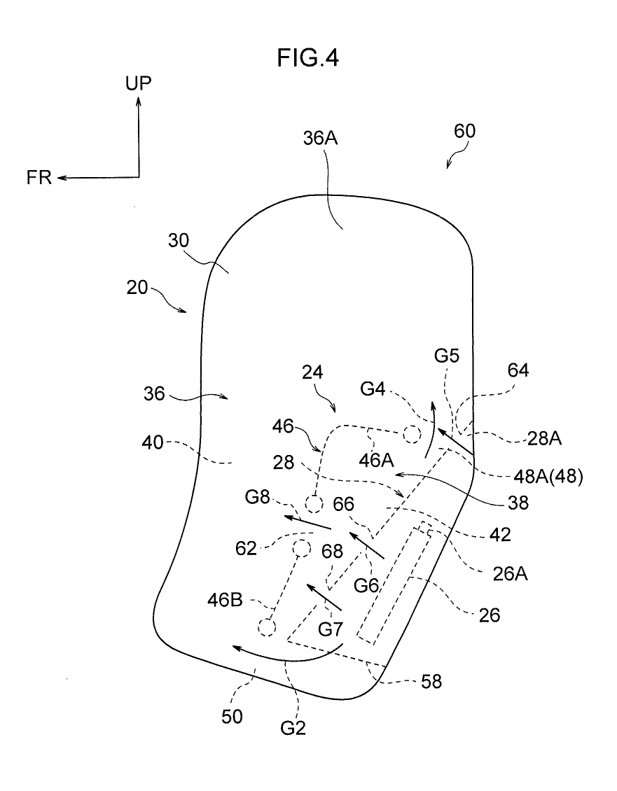

FIG. 4 is a side view illustrating the airbag 20 in the inflated and deployed state in a vehicle side airbag device 60 according to a second exemplary embodiment. Note that illustration of the outer peripheral stitch section 34 is not illustrated in FIG. 4. In the present exemplary embodiment, an intermediate communication opening 62 is provided at an up-down direction intermediate portion of the partitioning section 24. The intermediate communication opening 62 is formed by partially omitting the stitched section 46 at an up-down direction intermediate portion of the upright extension portion 46B.

In the present exemplary embodiment, the upper end portion 28A of the diffuser 28 is formed with an upper side opening 64 that places the interior of the diffuser 28 and the interior of the front bag section 36 (the interior of the head protection portion 36A) in communication with each other. An up-down direction intermediate portion of the diffuser 28 is formed with a pair of upper and lower intermediate openings 66, 68 that place the interior of the diffuser 28 and the interior of the rear bag section 38 in communication with each other. Namely, in the present exemplary embodiment, the openings (upper side opening 64, intermediate openings 66, 68) are formed at the upper end side than the lower end of the diffuser 28. The upper side opening 64 and the intermediate openings 66, 68 open diagonally toward the front upper side of the airbag 20.

In the present exemplary embodiment, when gas is ejected into the diffuser 28 from the gas ejection portion 26A of the inflator 26, in addition to a portion of the gas G2 ejected from the lower end opening 58 of the diffuser 28, gas G6, G7 ejected from the intermediate openings 66, 68 of the diffuser 28 is also supplied into the rear bag section 38. Moreover, in addition to the gas G4 that passes through the gas flow-path region 48A of the upper communication opening 48, gas G5 ejected from the upper side opening 64 of the diffuser 28 is also supplied to the upper portion inside the front bag section 36 (inside the head protection portion 36A). In addition to a portion of the gas G2 ejected from the lower end opening 58 of the diffuser 28, gas G8 ejected from the intermediate communication opening 62 of the partitioning section 24 is also supplied to the lower portion inside the front bag section 36.

Other configuration is similar to that of the first exemplary embodiment. In the present exemplary embodiment, configuration is also such that, during operation of the inflator 26, the internal pressure P1 of the diffuser 28 with the inflator 26 housed inside becomes higher than the internal pressure P2 of the rear bag section 38, and the internal pressure P2 of the rear bag section 38 with the inflator 26 and the diffuser 28 provided inside becomes higher than the internal pressure P3 of the front bag section 36.

In the present exemplary embodiment too, the lower pressure front bag section 36 can be supported by the higher pressure rear bag section 38. The upper end portion 28A of the diffuser 28 that inflates at a higher pressure pierces through the upper communication opening 48, thereby enabling unintentional folding of the airbag 20 originating at the upper communication opening 48 to be prevented or suppressed. The head protection portion 36A can be stably inflated and deployed from bottom to top due to a favorable balance of flow rates of the gas G4, G5, and flow rates of the gas G2, G8. Thus, basically the same operation and effects to those in the first exemplary embodiment are obtained.

In the present exemplary embodiment, gas inside the diffuser 28 is emitted to the outside of the diffuser 28 from the upper side opening 64 and the intermediate openings 66, 68, in addition to being emitted to the outside of the diffuser 28 from the lower end opening 58. Adding openings to the diffuser 28 and optimizing emission from the diffuser 28 in this manner enables an excessive rise in the internal pressure of the diffuser 28 to be prevented. This accordingly contributes to preventing the airbag 20 from bursting in the vicinity of the diffuser 28 (for example, in the vicinity of the upper end portion 28A).

In the present exemplary embodiment, a portion of the gas supplied into the rear bag section 38 is supplied (emitted) into the front bag section 36 from the intermediate communication opening 62, in addition to portions passing through the gas flow-path region 48A of the upper communication opening 48 and the lower communication opening 50 and supplied (emitted) into the front bag section 36. Adding the communication opening to the partitioning section 24 and optimizing emission from the rear bag section 38 in this manner enables an excessive rise in the internal pressure of the rear bag section 38 to be prevented. This accordingly contributes to preventing the airbag 20 from bursting in the vicinity of the rear bag section 38. By adding the intermediate communication opening 62, gas can be supplied to the lower portion inside the front bag section 36 through the intermediate communication opening 62, even in cases in which, for example, the lower communication opening 50 is blocked due to the vicinity of the lower communication opening 50 in the airbag 20 being impeded by a console box or the like.

### Third Exemplary Embodiment

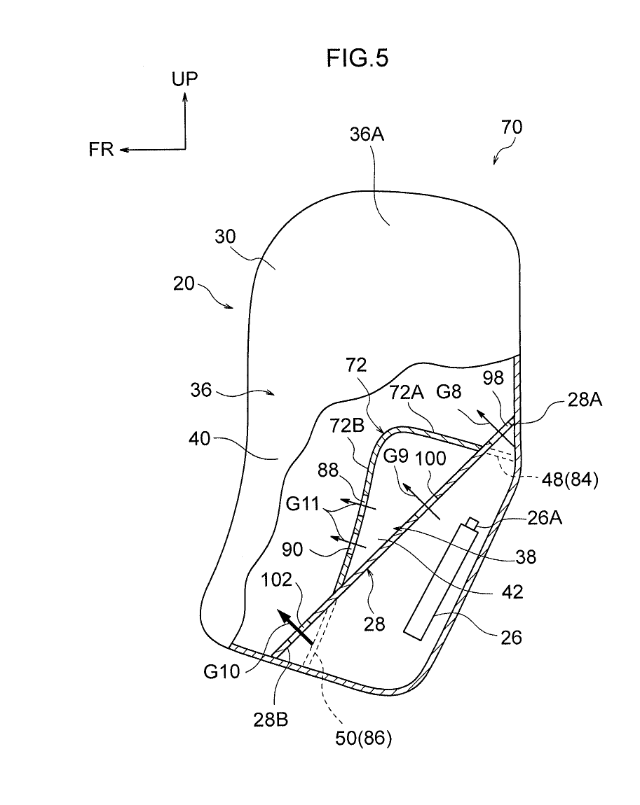

FIG. 5 is a side view illustrating the inflated and deployed state of the airbag 20 in a vehicle side airbag device 70 according to a third exemplary embodiment. Note that the outer peripheral stitch section 34 is not illustrated in FIG. 5. In the present exemplary embodiment, a tether 72, serving as a partitioning section, is provided at the airbag 20 instead of the partitioning section 24 according to the first exemplary embodiment. In the inflated and deployed state of the airbag 20, the tether 72 includes a crosswise extension portion 72A extending from the up-down direction intermediate portion in the vicinity of the rear end portion of the airbag 20 toward the front side of the seatback 14, and reaching the vicinity of the front-rear direction center portion of the airbag 20. An upright extension portion 72B extends from a front end portion of the crosswise extension portion 72A toward the lower end side of the airbag 20.

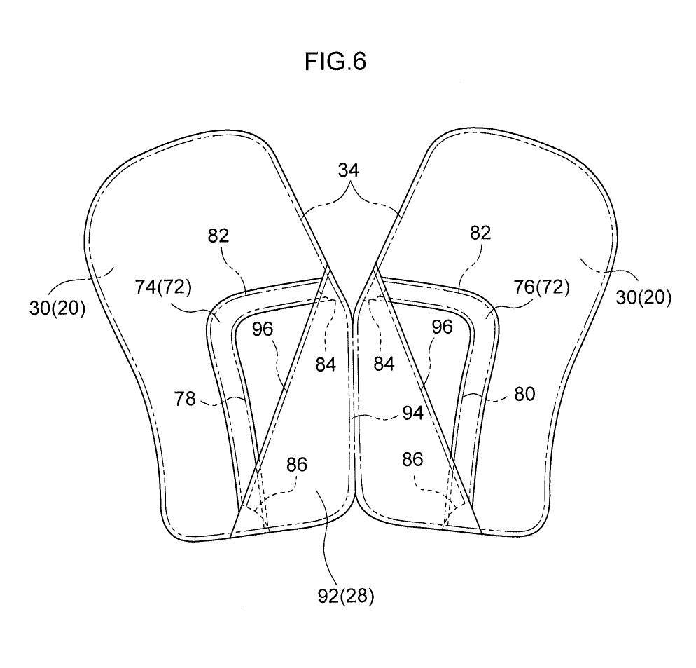

The tether 72 is configured by a pair of base cloths 74, 76, formed by cutting out a similar cloth material to the base cloths 30, 32 of the airbag 20 into elongated belt shapes (see FIG. 6). A long side edge portion at one side of one of the base cloth 74 is stitched to the base cloth 30 of the airbag 20 at a stitch portion 78, and a long side edge portion at one side of the other base cloth 76 is stitched to the base cloth 32 at a stitch portion 80. The long side edge portions on the other sides of the base cloths 74, 76 are stitched together at stitch portions 82. Cutouts 84, 86, for forming the upper communication opening 48 and the lower communication opening 50, respectively, are formed at both length direction end portions of the base cloths 74, 76. As illustrated in FIG. 5, a pair of upper and lower intermediate communication openings 88, 90 are formed at an up-down direction intermediate portion of the tether 72. The intermediate communication openings 88, 90 are formed, for example, by partially omitting the stitch portions 82 at the up-down direction intermediate portion of the tether 72.

In the present exemplary embodiment, as illustrated in FIG. 6, the diffuser 28 is formed by folding a base cloth 92, cut into a substantially triangular shape, into two along a fold line 94, and stitching together edge portions on the opposite side to the fold line 94 at stitch portions 96. The upper end portion 28A of the diffuser 28 pierces through the upper communication opening 48 and projects into the upper portion inside the front bag section 36 (inside the head protection portion 36A). A lower end portion 28B of the diffuser 28 pierces through the lower communication opening 50 and projects into the lower end portion inside the front bag section 36.

Note that in the present exemplary embodiment, configuration is such that no gap is formed between the upper end portion 28A of the diffuser 28 and the edge portions of the upper communication opening 48, or between the lower end portion 28B of the diffuser 28 and edge portions of the lower communication opening 50; however, configuration is not limited thereto. Namely, a configuration may be made such that gaps, each similar to the gas flow-path region 48A according to the first exemplary embodiment, are formed between the upper end portion 28A of the diffuser 28 and the edge portions of the upper communication opening 48, and between the lower end portion 28B of the diffuser 28 and the edge portions of the lower communication opening 50.

The upper end portion 28A of the diffuser 28 is formed with an upper side opening 98 that places the upper end portion inside the diffuser 28 and the upper portion inside the front bag section 36 in communication with each other. An up-down direction intermediate portion of the diffuser 28 is formed with an intermediate opening 100 that places the up-down direction intermediate portion inside the diffuser 28 and an up-down direction intermediate portion inside the rear bag section 38 in communication with each other. The lower end portion 28B of the diffuser 28 is formed with a lower side opening 102 that places the lower end portion inside the diffuser 28 and the lower end portion inside the front bag section 36 in communication with each other. Note that the stitching method illustrated in FIG. 6 is merely an example, and may be changed as appropriate.

In the present exemplary embodiment, as illustrated in FIG. 5, when gas is ejected from the gas ejection portion 26A of the inflator 26 into the diffuser 28, gas G8 ejected from the upper side opening 98 of the diffuser 28 is supplied to the upper portion inside the front bag section 36. Gas G9 ejected from the intermediate opening 100 of the diffuser 28 is supplied into the rear bag section 38. Gas G10 ejected from the lower side opening 102, and gas G11 ejected from the intermediate communication openings 88, 90 is supplied to the lower portion inside the front bag section 36.

Other configuration is similar to that of the first exemplary embodiment. In the present exemplary embodiment, configuration is also such that, during operation of the inflator 26, the internal pressure P1 of the diffuser 28 with the inflator 26 housed inside becomes higher than the internal pressure P2 of the rear bag section 38, and the internal pressure P2 of the rear bag section 38 with the inflator 26 and the diffuser 28 provided inside becomes higher than the internal pressure P3 of the front bag section 36.

In the present exemplary embodiment too, the lower pressure front bag section 36 can be supported by the higher pressure rear bag section 38. The upper end portion 28A of the diffuser 28 that inflates at a higher pressure pierces through the upper communication opening 48, thereby enabling unintentional folding of the airbag 20 originating at the upper communication opening 48 to be prevented or suppressed. The head protection portion 36A can be stably inflated and deployed from bottom to top due to a favorable balance of the flow rate of the gas G8 and the flow rates of the gas G10, G11. Thus, basically the same operation and effects to those in the first exemplary embodiment are obtained.

In the present exemplary embodiment, gas inside the diffuser 28 is emitted to the outside of the diffuser 28 from the upper side opening 98, the intermediate opening 100, and the lower side opening 102. Optimizing emission from these openings enables an excessive rise in the internal pressure of the diffuser 28 to be prevented. This accordingly contributes to preventing the airbag 20 from bursting in the vicinity of the diffuser 28 (for example, in the vicinity of the upper end portion 28A).

In the present exemplary embodiment, a portion of the gas G9 supplied into the rear bag section 38 is supplied (emitted) into the front bag section 36 from the intermediate communication openings 88, 90. Forming communication openings to the tether 72 and optimizing emission from the rear bag section 38 in this manner enables an excessive rise in the internal pressure of the rear bag section 38 to be prevented. This accordingly contributes to preventing the airbag 20 from bursting in the vicinity of the rear bag section 38. By forming the intermediate communication openings 88, 90, gas can be supplied to the lower portion inside the front bag section 36 through the intermediate communication openings 88, 90, even in cases in which, for example, the lower side opening 102 is blocked due to the vicinity of the lower side opening 102 in the diffuser 28 being impeded by a console box or the like.

### Additional Explanation of Exemplary Embodiments

In the second exemplary embodiment, configuration is such that the intermediate openings 66, 68 are formed at the diffuser 28; however, embodiments are not limited thereto, and a configuration may be made such that intermediate openings are omitted.

In the second exemplary embodiment and the third exemplary embodiment, configuration is such that the intermediate communication openings 62, 88, 90 are formed at the partitioning section 24 and the tether 72; however, embodiments are not limited thereto, and a configuration may be made such that intermediate communication openings are omitted.

In each of the above exemplary embodiments, the diffuser 28 is configured so as to increase in diameter on progression from the upper end toward the lower end thereof; however, embodiments are not limited thereto. A configuration may be applied, for example, in which a diffuser is formed in a cylindrical shape with the same diameter from an upper end to a lower end thereof.

In each of the above exemplary embodiments, cases have been explained in which the vehicle side airbag device 10, 60, 70 is installed at the center-side side section 14A of the seatback 14 of the vehicle seat 12 (the side section at the vehicle width direction center side); however, embodiments are not limited thereto. Namely, the present disclosure may also be applied to a vehicle side airbag device installed at a side section at the vehicle width direction outside of a seatback of a vehicle seat (a nearer side airbag device).

Moreover, various modifications may be implemented within a range not departing from the spirit of the present disclosure. Obviously, the scope of rights of the present disclosure is not limited by any of the previous exemplary embodiments.

What is claimed is:

1. A vehicle side airbag device comprising:
an inflator that is disposed at a side section of a seatback of a vehicle seat;
a rear bag section that inflates and deploys using gas from the inflator housed inside the rear bag section;
a front bag section into which gas is supplied through a plurality of communication openings formed at a partitioning section between the front bag section and the rear bag section, that inflates and deploys toward a vehicle front side and a vehicle upper side of the rear bag section, and that protects a head of an occupant at a location at a vehicle upper side than the rear bag section; and
a diffuser that is disposed inside the rear bag section, that houses the inflator and inflates using gas from the inflator, wherein an upper end portion of the diffuser, which is a portion at a location that inflates, pierces through an upper communication opening that is one of the plurality of communication openings and that is formed at an upper end portion of the partitioning section.

2. The vehicle side airbag device of claim 1, wherein a gas flow-path region, for supplying a portion of gas supplied into the rear bag section from the diffuser to an upper portion inside the front bag section, is formed at the upper communication opening into which the upper end portion of the diffuser pierces through.

3. The vehicle side airbag device of claim 2, wherein:
the plurality of communication openings comprises a lower communication opening formed at a lower end portion of the partitioning section; and
a cross-section area of the gas flow-path region, when the rear bag section and the front bag section is inflated and deployed, is set smaller than an opening area of the lower communication opening.

4. The vehicle side airbag device of claim 2, wherein
the plurality of communication openings comprises a lower communication opening formed at a lower end portion of the partitioning section; and
the diffuser increases in diameter from an upper end toward a lower end thereof, and a lower end opening is formed at the lower end.

5. The vehicle side airbag device of claim 1, wherein
during operation of the inflator, an internal pressure of the diffuser is higher than an internal pressure of the rear bag section, and the internal pressure of the rear bag section is higher than an internal pressure of the front bag section.

6. The vehicle side airbag device of claim 4, wherein the diffuser comprises an opening that is formed at the upper end side than the lower end thereof.

7. The vehicle side airbag device of claim 1, wherein:
the plurality of communication openings comprise a lower communication opening formed at a lower end portion of the partitioning section; and
the diffuser comprises:
an upper side opening that is formed at an upper end portion thereof, and that places an interior of the diffuser and an interior of the front bag section in communication with each other;
an intermediate opening that is formed at an up-down direction intermediate portion thereof, and that places the interior of the diffuser and an interior of the rear bag section in communication with each other;
a lower end portion that pierces through the lower communication opening; and
a lower side opening that is formed at the lower end portion, and that places the interior of the diffuser and the interior of the front bag section in communication with each other.

8. The vehicle side airbag device of claim 2, wherein the plurality of communication openings comprise an intermediate communication opening formed at an up-down direction intermediate portion of the partitioning section.

9. The vehicle side airbag device of claim 1, wherein the upper end portion of the diffuser that pierces through the upper communication opening is closed.

10. The vehicle side airbag device of claim 1, wherein an upper side opening that places an interior of the diffuser and an interior of the front bag section in communication with each other is formed at the upper end portion of the diffuser that pierces through the upper communication opening.

11. The vehicle side airbag device of claim 10, wherein the upper side opening is open diagonally toward a front upper side of the front airbag.
